(19) United States
(12) Patent Application Publication
(10) Pub. No.: US 2010/0162181 A1
(43) Pub. Date: Jun. 24, 2010

(54) Interpreting Gesture Input Including Introduction Or Removal Of A Point Of Contact While A Gesture Is In Progress

(75) Inventors: Daniel Marc Gatan Shiplacoff, Los Angeles, CA (US); Tom Hughes, Mountain View, CA (US); Johan Bjork, San Francisco, CA (US)

Correspondence Address: RAUBVOGEL LAW OFFICE, 820 LAKEVIEW WAY, REDWOOD CITY, CA, 94062, US

(73) Assignee: Palm, Inc., Sunnyvale, CA (US)

(21) Appl. No.: 12/341,981

(22) Filed: Dec. 22, 2008

(51) Int. Cl. G06F 3/033; G06F 3/041

(52) U.S. Cl. 715/863; 345/173

(57) ABSTRACT

A touch-sensitive device accepts single-touch and multi-touch input representing gestures, and is able to changing a parameter of a gesture responsive to introduction or removal of a point of contact while the gesture is in progress. The operation associated with the gesture, such as a manipulation of an on-screen object, changes in a predictable manner if the user introduces or removes a contact point while the gesture is in progress. The overall nature of the operation being performed does not change, but a parameter of the operation can change. In various embodiments, each time a contact point is added or removed, the system and method of the present invention resets the relationship between the contact point locations and the operation being performed, in such a manner as to avoid or minimize discontinuities in the operation. In this manner, the invention avoids sudden or unpredictable changes to an object being manipulated.

### FIELD OF THE INVENTION

In various embodiments, the present invention relates to gesture input for controlling electronic devices, and more particularly to changing a parameter of a gesture responsive to introduction or removal of a point of contact while the gesture is in progress.

### DESCRIPTION OF THE RELATED ART

It is well-known to provide touch-sensitive surfaces and touch-sensitive display screens for electronic devices. Touch-sensitive surfaces, referred to as “touchpads,” allow users to provide input by touch. A touch-sensitive display screen, also referred to as a “touchscreen,” is a touch-sensitive surface that also functions as (or is overlaid on) a display device. Touchscreens are particularly effective for implementing direct manipulation techniques, as users can interact with objects displayed on the screen, for example by touching the screen at a location where an object is displayed.

In general, touchscreens are able to detect a location of user contact with the display area. Users typically interact with a touchscreen using a finger, a stylus, or some other pointing object. The user can perform various input actions, including tapping, touching, pressing, dragging, and the like. More sophisticated input actions can also be performed. Touch-based input actions provided on a touchscreen are collectively referred to as “gestures.” Many gestures involve initiating contact at a point on the surface (the “contact point”) and dragging the finger (or other pointing object) along the surface to move the contact point in a manner that indicates the nature of the operation to be performed.

It is well known to provide gestures that allow direct manipulation of on-screen objects using a touchscreen or touchpad. Such techniques are useful for performing many different types of operations on on-screen objects, including moving, scrolling, zooming, scaling, distorting, stretching, rotating, and the like.

For example, a user can move an on-screen object by touching the screen at the location where the object is displayed, and dragging his or her finger (or other object such as a stylus) along the screen while maintaining contact with the screen. This input action is referred to as a “touch-hold-drag” gesture. The on-screen object moves along with the user's finger. When the user releases his or her finger, the object is dropped at the corresponding location, if the location is a valid destination for the object. A similar action can be performed on a touchpad that is separate from the display screen.

A touch-hold-drag gesture can also be used, in many systems, to invoke a scrolling operation in a direction corresponding to the drag gesture, or in some cases in a direction opposite that of the drag gesture.

Some touchscreens are capable of interpreting two or more simultaneous points of contact; this is commonly referred to as “multi-touch” technology. For example, the iPhone, available from Apple Inc. of Cupertino, Calif., includes a multi-touch screen that allows a user to control zooming operations via a “pinch” gesture. The user makes contact with the screen at two locations on the on-screen object, for example using a thumb and finger. While maintaining contact with the screen, the user brings the thumb and finger farther apart to zoom in on the on-screen object, causing the object to be magnified. Conversely, the user can bring the thumb and finger closer together to zoom out. In many such systems, the degree of magnification is proportional to the change in distance between the two points of contact from the beginning to the end of the gesture.

Many other types of gestures are known, including both single touch and multi-touch gestures, for both touchscreens and touchpads.

In general, conventional systems can accept single-touch and/or multi-touch gestures, but are not capable of reliably interpreting gestures where a point of contact is added or removed while a gesture is in progress. For example, if a user begins a multi-touch gesture with two fingers, and then introduces a third finger while the gesture is in progress, conventional systems have no way of reliably interpreting the input. The third finger may simply be ignored, or it may be interpreted as replacing one of the existing points of contact, or it may cause unpredictable results as the system attempts to discern two points of contact when three are presented. Similar problems exist if a point of contact is removed while a gesture is in progress.

What is needed is a touch-sensitive input device that is capable of reliably interpreting touch input including the introduction and/or removal of a point of contact while the gesture is in progress. What is further needed is a touch-sensitive input device that provides a user with a greater degree of control for input operations by allowing the user to add or remove a point of contact while a gesture is in progress. What is further needed is a system and method that avoids the limitations of existing touch-based input devices, and that provides enhanced control and an improved user experience in an intuitive manner, and without introducing excessive complexity to the user interaction.

### SUMMARY OF THE INVENTION

According to various embodiments of the present invention, a touch-sensitive device accepts single-touch and multi-touch input representing gestures, and is also able to changing a parameter of a gesture responsive to introduction or removal of a point of contact while a gesture is in progress. In some embodiments, the invention is implemented in a touchscreen or similar display device capable of accepting touch input. In other embodiments, the invention is implemented in a touchpad or similar device that accepts touch input but does not act as a display device. In such an implementation, a separate output device, such as a display screen, can be provided to show the results of the gesture.

In various embodiments, a user interacts with a device by touching a surface to initiate a gesture. The gesture can include one point of contact or multiple points of contact. For each point of contact, a finger or stylus can be used. The gesture may be static, involving substantially no movement once contact has been initiated, or it can be a dynamic gesture that includes movement of one or more contact points. The device interprets the touch-based input and performs an operation in response to the input. For example, an onscreen object can be moved, resized, rotated, or otherwise manipulated in response to the touch-based input. In one embodiment, the manipulation or transformation of the object continues as long as the user continues the gesture. Thus, gestures can be performed over a period of time, such as for example several seconds, depending on the user's wishes.

In various embodiments, particular characteristics of the gesture determine parameters of the operation performed by the device. For example, if a user uses a pinch gesture to change the size of an on-screen object, the change in distance between the user's fingers from the beginning to the end of the pinch gesture determines the scaling factor for the operation. In one embodiment, the linear scaling factor is proportional to the change in distance between the user's fingers from the beginning to the end of the pinch gesture, so that a change in distance from two centimeters to four centimeters would cause the displayed object to double in size along one axis.

In various embodiments, the operation associated with the gesture, such as a manipulation of an on-screen object, changes in a predictable manner if the user introduces or removes a contact point while the gesture is in progress. In various embodiments, the overall nature of the operation being performed does not change, but a parameter (such as a scaling factor) does change. In other embodiments, introduction or removal of a contact point does change the nature of the operation.

In various embodiments, each time a contact point is added or removed, the system and method of the present invention resets the relationship between the contact point locations and the operation being performed, in such a manner as to avoid or minimize discontinuities in the operation. In this manner, the invention avoids sudden or unpredictable changes to the object being manipulated.

For example, suppose a user initiates a zoom gesture (such as a pinch gesture) with two contact points, to enlarge an on-screen object. As described above, the on-screen object is scaled in proportion to the change in distance between the two contact points. If the user then introduces a third contact point while the pinch gesture is in progress, no immediate discontinuous change takes place upon the introduction of the new contact point. However, if the user continues to move at least one contact point after introducing the third contact point, additional zooming takes place in proportion to the change in area of the triangle formed by the three contact points. In this manner, movement of any of the contact points is interpreted in a predictable manner according to the three contact points rather than two contact points.

As another example, if a user initiates a scroll gesture by moving a finger across a screen, the resulting scroll operation has a magnitude and/or speed determined by the amount of movement of the user's finger and/or the speed of movement of the user's finger. In various embodiments of the present invention, the user can adjust the magnitude and/or speed by introducing a second finger (point of contact) while the scroll gesture is in progress. For example, a second contact point can cause the scroll operation to be performed at a higher speed until the second contact point is removed. In one embodiment, the shift from lower to higher speed is performed smoothly and without discontinuities in the scroll operation.

In various embodiments, additional changes to the number of contact points are interpreted in an intelligent manner to avoid unpredictability and discontinuity, and to provide the user with greater control when manipulating on-screen objects and performing other operations.

Additional advantages will become apparent in the following detailed description.

### BRIEF DESCRIPTION OF THE DRAWINGS

The accompanying drawings illustrate several embodiments of the invention and, together with the description, serve to explain the principles of the invention. One skilled in the art will recognize that the particular embodiments illustrated in the drawings are merely exemplary, and are not intended to limit the scope of the present invention.

FIG. 1 depicts an example of a device having a touch-sensitive display screen for implementing the invention according to one embodiment.

FIG. 2 is a flowchart depicting a method of changing a parameter of a gesture responsive to introduction or removal of a point of contact while the gesture is in progress, according to one embodiment of the present invention.

FIG. 3 is a flowchart depicting a method of changing a parameter of a zoom gesture responsive to introduction or removal of a point of contact while the gesture is in progress, according to one embodiment of the present invention.

FIG. 4 is a flowchart depicting a method of changing speed of a scroll gesture responsive to introduction or removal of a point of contact while the gesture is in progress, according to one embodiment of the present invention.

FIG. 5 is a flowchart depicting a method of changing a parameter of a rotate gesture responsive to introduction or removal of a point of contact while the gesture is in progress, according to one embodiment of the present invention.

FIGS. 6A through 6F depict an example of a zoom gesture including introduction and removal of a point of contact while the gesture is in progress, according to one embodiment of the present invention.

FIGS. 7A through 7F depict an example of the effect of a zoom gesture on an on-screen object, including introduction and removal of a point of contact while the gesture is in progress, according to one embodiment of the present invention.

FIGS. 8A through 8C depict an example of a scroll gesture including introduction and removal of a point of contact while the gesture is in progress, according to one embodiment of the present invention.

FIGS. 9A through 9E depict an example of the effect of a rotate gesture on an on-screen object, including introduction of a point of contact while the gesture is in progress, according to one embodiment of the present invention.

### DETAILED DESCRIPTION OF THE EMBODIMENTS

### System Architecture

In various embodiments, the present invention can be implemented on any electronic device, such as a handheld computer, desktop computer, laptop computer, personal digital assistant (PDA), personal computer, kiosk, cellular telephone, remote control, data entry device, and the like. For example, the invention can be implemented as part of a user interface for a software application or operating system running on such a device.

In particular, many such devices include touch-sensitive display screens that are intended to be controlled by a user's finger, and wherein users can initiate and control various operations on on-screen objects by performing gestures with a finger, stylus, or other pointing implement.

One skilled in the art will recognize, however, that the invention can be practiced in many other contexts, including any environment in which it is useful to provide an improved interface for controlling and manipulating objects displayed on a screen. Various embodiments of the invention can be implemented using any touch-sensitive technology, including but not limited to touch-screens, touchpads, and the like.

Accordingly, the following description is intended to illustrate the invention by way of example, rather than to limit the scope of the claimed invention.

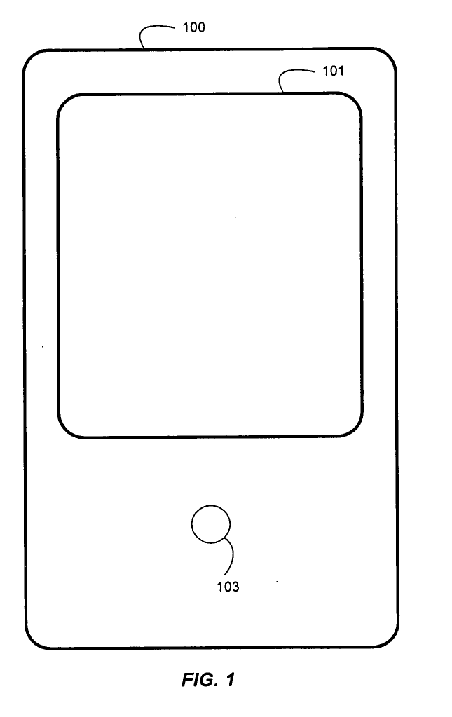

Referring now to FIG. 1, there is shown an example of an example of a device 100 having a touch-sensitive display screen 101 that can be used for implementing the present invention according to one embodiment. In various embodiments, the operation of the present invention is controlled by a processor (not shown) of device 100 operating according to software instructions of an operating system and/or application.

In one embodiment, device 100 as shown in FIG. 1 also has a physical button 103. In one embodiment, physical button 103 can be used to perform some common function, such as to return to a home screen or to activate a selected on-screen item. Physical button 103 is not needed for the present invention, and is shown for illustrative purposes only. One skilled in the art will recognize that any number of such buttons 103, or no buttons 103, can be included, and that the number of physical buttons 103, if any, is not important to the operation of the present invention.

For illustrative purposes, device 100 as shown in FIG. 1 is a personal digital assistant or smartphone. Such devices commonly have telephone, email, and text messaging capability, and may perform other functions including, for example, playing music and/or video, surfing the web, running productivity applications, and the like. The present invention can be implemented in any type of device having a touch-sensitive display screen, and is not limited to devices having the listed functionality. In addition, the particular layout shown in FIG. 1 is merely exemplary and is not intended to be restrictive of the scope of the claimed invention. For example, screen 101, button 103, and other components can be arranged in any configuration; the particular arrangement and appearance shown in FIG. 1 is merely one example.

In various embodiments, touch-sensitive display screen 101 can be implemented using any technology that is capable of detecting a location for a point of contact. One skilled in the art will recognize that many types of touch-sensitive display screens and surfaces exist and are well-known in the art, including for example:
capacitive screens/surfaces, which detect changes in a capacitance field resulting from user contact;
resistive screens/surfaces, where electrically conductive layers are brought into contact as a result of user contact with the screen or surface;
surface acoustic wave screens/surfaces, which detect changes in ultrasonic waves resulting from user contact with the screen or surface;
infrared screens/surfaces, which detect interruption of a modulated light beam or which detect thermal induced changes in surface resistance;
strain gauge screens/surfaces, in which the screen or surface is spring-mounted, and strain gauges are used to measure deflection occurring as a result of contact;
optical imaging screens/surfaces, which use image sensors to locate contact;
dispersive signal screens/surfaces, which detect mechanical energy in the screen or surface that occurs as a result of contact;
acoustic pulse recognition screens/ surfaces, which turn the mechanical energy of a touch into an electronic signal that is converted to an audio file for analysis to determine location of the contact; and
frustrated total internal reflection screens, which detect interruptions in the total internal reflection light path.

Any of the above techniques, or any other known touch detection technique, can be used in connection with the device of the present invention, to detect user contact with screen 101, either with a finger, or with a stylus, or with any other object.

In one embodiment, the present invention can be implemented using a screen 101 capable of detecting two or more simultaneous touch points, according to techniques that are well known in the art.

In other embodiments, the invention is implemented in a touchpad or similar device that accepts touch input but does not act as a display device. In such an implementation, a separate output device, such as a display screen (not shown), can be provided to show the output generated by the present invention, and to give the user visual feedback as to the gesture being input and the effect of the gesture on on-screen objects.

In one embodiment, the present invention can be implemented using other recognition technologies that do not necessarily require contact with the device. For example, a gesture may be performed proximate to the surface of screen 101, or it may begin proximate to the surface of screen 101 and terminate with a touch on screen 101. It will be recognized by one with skill in the art that the techniques described herein can be applied to such non-touch-based gesture recognition techniques.

### Method

According to various embodiments of the present invention, device 100 accepts single-touch and multi-touch input representing gestures, and is able to changing a parameter of a gesture responsive to introduction or removal of a point of contact while the gesture is in progress. In the following descriptions, the operation of the invention is set forth in terms of gesture input provided via touchscreen 101. However, one skilled in the art will recognize that the techniques of the invention can be implemented in a touchpad or similar device that accepts touch input but does not necessarily act as a display device.

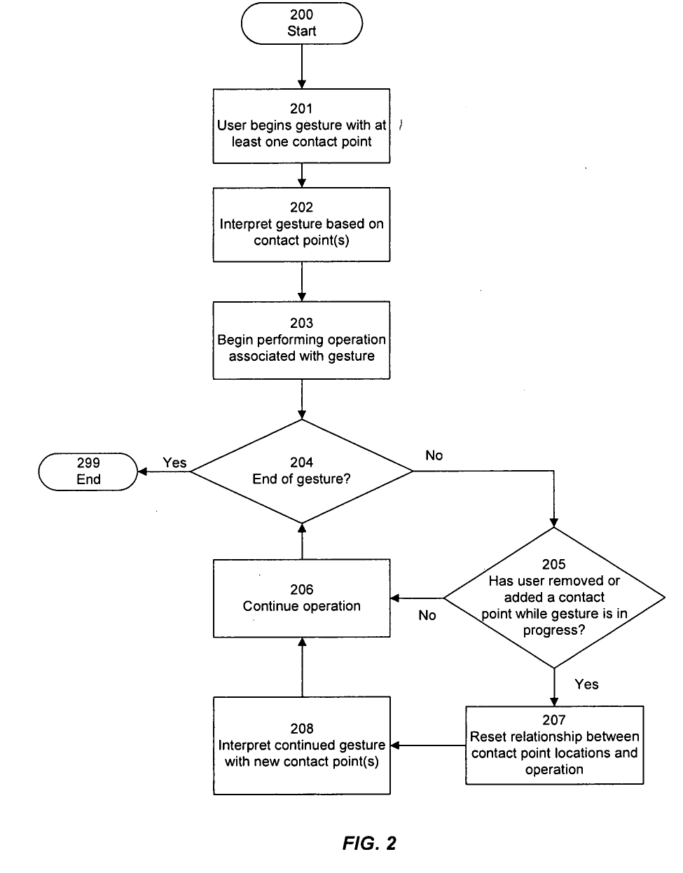

Referring now to FIG. 2, there is shown a flowchart depicting a method of changing a parameter of a gesture responsive to introduction or removal of a point of contact while the gesture is in progress, according to one embodiment of the present invention.

A user begins 201 a gesture, for example by touching screen 101 with one or more fingers. Alternatively, any other pointing implement can be used, such as a stylus, although for illustrative purposes in the following description the pointing implement will be referred to as the user's finger.

The point where the user touches screen 101 is referred to as a contact point. Thus, in step 201, the gesture begins with one or more contact points.

Typically, though not necessarily, the gesture involves some sort of movement of the contact point(s). For example, a scroll gesture can involve simple linear movement of a finger while in contact with screen 101. As another example, a zoom gesture can involve movement of two fingers while in contact with screen 101, in a pinching gesture. Alternatively, a gesture can be interpreted based solely on the position of the contact point(s) without requiring any movement.

Device 100 interprets 202 the user's gesture based on the location and/or movement of the contact point(s). The specific interpretation of the user's gesture can depend on many factors, including the object(s) displayed at the contact point(s), the nature of the application or function being executed at the time the gesture is initiated, the capabilities of device 100, user preference, and the like. For example, one interpretation of a scroll gesture is to move an object, window, pane, or other item on the screen, possibly revealing a portion of the item that was not previously displayed. As another example, an interpretation of a zoom gesture is to change the size of a displayed object. In one embodiment, the appropriate operation is performed on an object that is currently displayed at or near the contact point (or one or more of the contact points); for example, a zoom gesture might change the size of an item, such as a photograph, located at the point where the gesture is performed. In alternative embodiments, gestures can have an effect on objects or items that are not located at the contact point(s); for example, in an embodiment where the present invention is implemented on a touchpad, the object or item being manipulated can be displayed on a screen that is separate from the input device that accepts the user's gestures.

Device 100 begins 203 performing an operation associated with the user's gesture. For example, device 100 zooms or rotates an object in response to a zoom or rotate gesture, or scrolls at least a portion of the screen in response to a scroll gesture. In one embodiment, the operation continues as long as the gesture is being performed. Thus, if a zoom gesture is being performed, the zoom operation would continue as long as the user continues to move his or her fingers farther apart (or closer together). In one embodiment, the user can vary some parameter of the operation by changing the gesture as it is being performed. For example, if a zoom operation is being performed in response to a zoom gesture, the user can move his or fingers closer together or father apart to dynamically change the zoom level.

If the end of the gesture is reached 204, the method ends 299. If the end of the gesture is not reached 204 (in other words, the user continues to perform the gesture), device 100 determines 205 whether the user has removed a contact point while performing the gesture. If no contact point has been removed or added, the operation specified by the gesture is continued 206. As described above, some parameter of the operation may change if the user changes the contact point location(s) while performing the gesture. Accordingly, in one embodiment, step 206 includes determining whether any such changes should be reflected in the continued operation.

If, in step 205, the user has removed or added a contact point while performing the gesture, device 100 resets 207 the relationship between the location(s) of the contact point(s) and the operation being performed, so that future movement of one or more contact point(s) will be interpreted based on the newly reset relationship.

In one embodiment, the relationship is reset 207 in a manner that avoids any substantial discontinuity in the display before and after the introduction or removal of the contact point. Thus, in one embodiment the introduction or removal of the contact point does not itself cause any substantial change to an object(s) being manipulated; however, continuation of the gesture potentially causes subsequent change to the object based on the newly reset relationship between the object(s) and the contact point(s).

Once the relationship has been reset 207, device 100 then interprets 208 the continued gesture using the new contact point(s) and according to the new relationship between the operation and the contact point(s) location(s). Based on this interpretation, device 100 continues 206 the operation.

Device continues to check 204 whether the user has finished inputting the gesture, returning to steps 205 to 208 if the gesture continues. If the end of the gesture is reached 204, the method ends 299.

### Example: Zoom Gesture

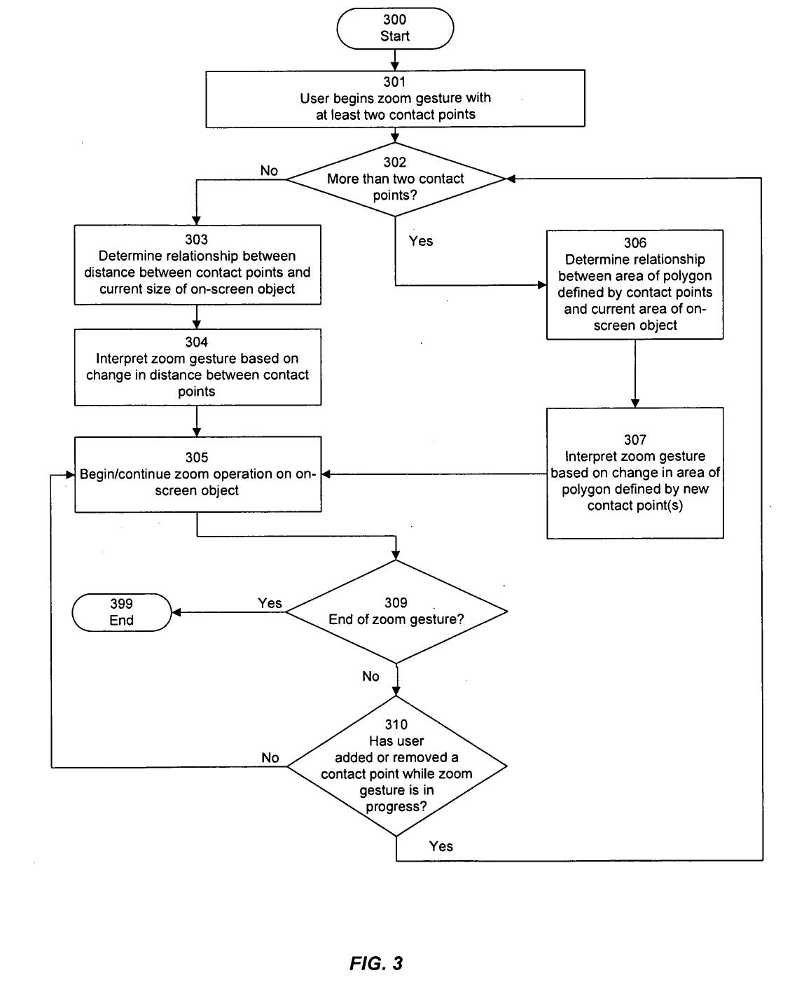

Referring now to FIG. 3, there is shown a flowchart depicting an example of a method of applying the present invention in a specific context, namely to change a parameter of a zoom gesture responsive to introduction or removal of a point of contact while the gesture is in progress, according to one embodiment of the present invention. The user begins 301 a zoom gesture with at least two contact points. For example, the user may begin the gesture by placing two fingers on the on-screen object to be zoomed.

A determination is made 302 whether the gesture includes more than two contact points. If exactly two contact points are included, the zoom operation will be performed according to the change in distance between the two contact points. A relationship is determined 303 between the distance between the contact points and the current size of the object being manipulated by the zoom operation. The current size of the object can be expressed in terms of a linear dimension, or an area, or some other methodology. For example, if the contact points are two centimeters apart and the object is three centimeters tall, the relationship can be determined as a ratio of 1:1.5. Then, the zoom gesture is interpreted 304 based on the change in distance between the contact points as the user continues the zoom gesture. Device 100 begins 305 to perform the zoom operation on the on-screen object according to the interpreted zoom gesture. Thus, if the user moves the contact points from two centimeters apart to four centimeters apart, and the relationship was determined to be a ratio of 1:1.5, the on-screen object increases in size from three centimeters tall to six centimeters tall. Thus, in one embodiment, a doubling in distance between the contact points yields a doubling in size of the on-screen object along a linear dimension.

In this embodiment, then, the increase (or decrease) in distance between the contact points yields a proportional increase (or decrease) in object size along a linear dimension. In other embodiments, the increase (or decrease) in distance between the contact points can yields a proportional increase (or decrease) in object area. In yet other embodiments, other relationships can be used between the distance and the object size.

If, in step 302, more than two contact points are included, the zoom operation will be performed according to the change in the area of a polygon defined by the contact points. A relationship is determined 306 between the area of a polygon defined by the contact points and the current area of the object being manipulated by the zoom operation. The current size of the object can be expressed in terms of a linear dimension, or an area, or some other measuring paradigm. For example, if the area of the polygon is four square centimeters and the object has an area of five square centimeters, the relationship can be determined as a ratio of 1:1.25. Then, the zoom gesture is interpreted 307 based on the change in area of the constructed polygon as the user continues the zoom gesture. Device 100 begins 305 to perform the zoom operation on the on-screen object according to the interpreted zoom gesture. Thus, if the user moves the contact points so that the polygon area changes from four square centimeters to eight square centimeters, and the relationship was determined to be a ratio of 1:1.25, the on-screen object increases in area from five square centimeters to ten square centimeters. Thus, in one embodiment, a doubling in the area of the constructed polygon yields a doubling in area of the on-screen object.

In one embodiment, the polygon is not actually displayed on screen 101. In another embodiment, the polygon is shown on screen 101.

Device 100 determines 309 whether the zoom gesture has ended, for example by the user removing his fingers from screen 101. If so, the method ends 399.

If the zoom gesture has not ended, device 100 determines 310 whether the user has added or removed a contact point while continuing the zoom gesture. If not, the method returns to step 302 to continue to interpret the zoom gesture as before.

If the user has added or removed a contact point while continuing the zoom gesture, device returns to step 302. Step 303 or 306 is performed, so as to reset the relationship between the contact point locations and the current size of the object being manipulated. Specifically, if exactly two contact points are included, the relationship is determined 303 between the distance between the contact points and the size of the object. Conversely, if more than two contact points are included, the relationship is determined 306 between the area of a polygon defined by the contact points and the area of the object. The method then continues with either step 304 or 307, as described above.

In one embodiment, the relationship between contact points and the manipulated object is reset (by the determining steps 303 and/or 306) in a manner that avoids any substantial discontinuity in the display before and after the introduction or removal of the contact point. Thus, in one embodiment the introduction or removal of the contact point does not itself cause any substantial change to the size of the object being manipulated; however, continuation of the gesture potentially causes subsequent change to the object based on the newly determined relationship between the object and the contact points.

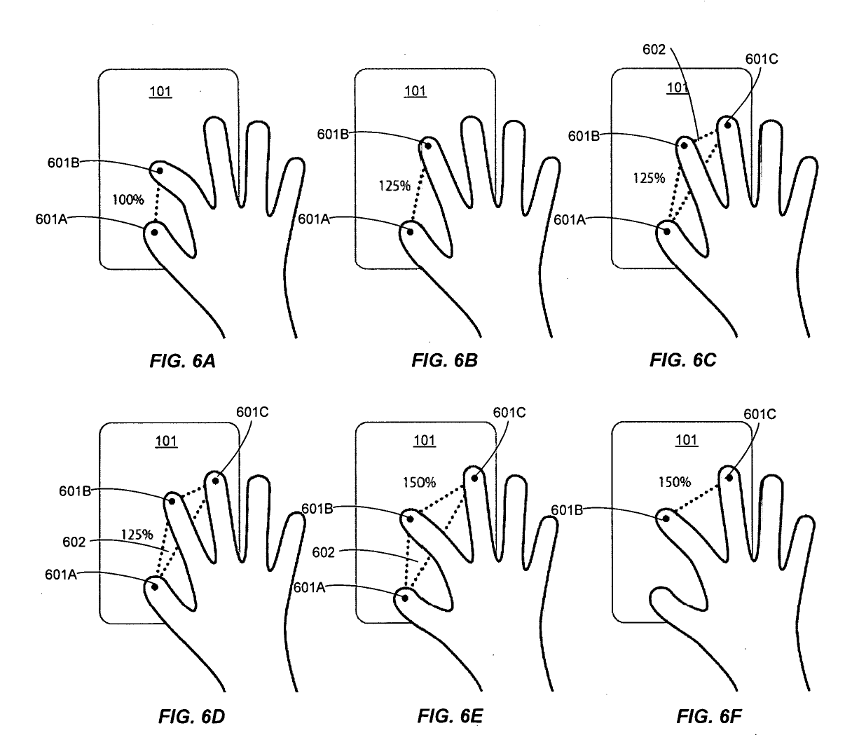

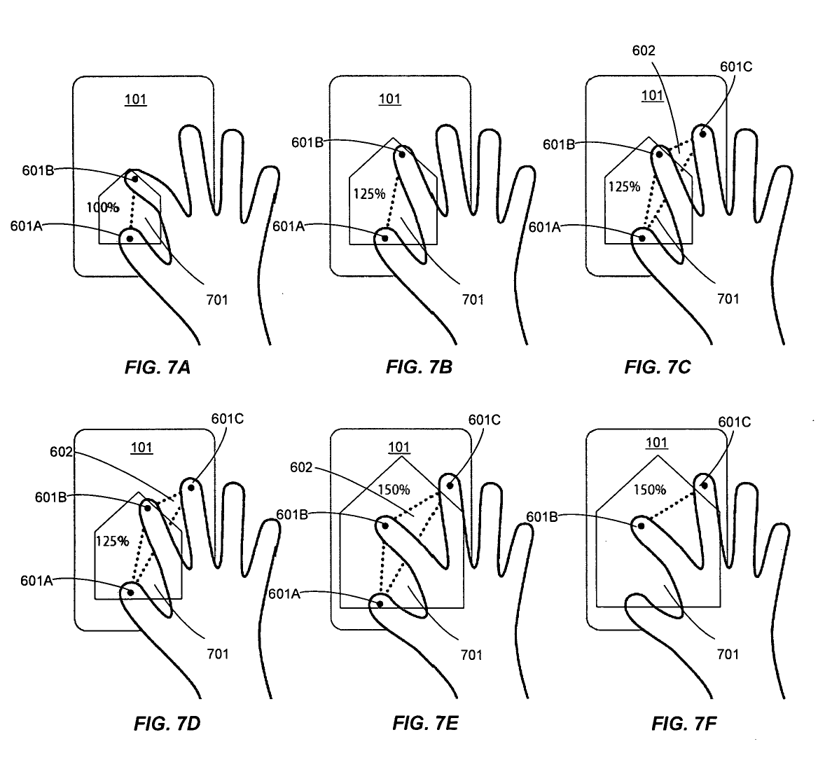

Referring now also to FIGS. 6A through 6F, there is shown an example of a zoom gesture including introduction and removal of a point of contact while the gesture is in progress, according to one embodiment of the present invention. Referring now also to FIGS. 7A through 7F, there is shown an example of the effect of a zoom gesture on an on-screen object, including introduction and removal of a point of contact while the gesture is in progress, according to one embodiment of the present invention. FIGS. 6A through 6F and 7A through 7F, along with the following description, are provided to further illustrate the operation of the invention as described in FIGS. 2 and 3 by way of example, and are not intended to limit the scope of the invention in any way.

In the example of FIGS. 6A through 6F and 7A through 7F, one continuous zoom gesture is performed. The user adds a contact point and removes a contact point in the process of performing the gesture, and the method of the invention interprets these changes to the gesture to alter the parameters of the zoom operation accordingly and predictably. No discontinuity in the display of object 701 is introduced, and the transition from one interpretation of contact points 601 to another is performed smoothly.

In FIGS. 6A and 7A, the user begins 301 a zoom gesture with two original contact points 601A, 601B. Since two contact points are provided 302, a relationship 303 is determined between the distance between contact points 601A, 601B and the current size of an on-screen object.

For purposes of clarity, no on-screen object is shown in FIGS. 6A through 6F, although such an object 701 is shown in FIG. 7A. In both FIGS. 6A and 7A, an indicator of “100%” is shown, specifying, in a relative form, an initial distance between contact points 601A, 601B.

In FIGS. 6B and 7B, the user moves his or her fingers while maintaining contact with screen 101, causing contact points 601A, 601B to move farther apart. As indicated, the distance between contact points 601A, 601B has increased to 125% of the original distance. The zoom gesture is interpreted 304 based on this change in distance between contact points 601A, 601B, and the zoom operation begins 305: specifically, the size of object 701 is increased so that it now has a linear dimension that is 125% of its original size.

In FIGS. 6C and 7C, the same gesture continues, but now the user has added 310 a third contact point 601C. Since more than two contact points are now provided 302, a relationship 306 is determined between the area of the polygon (specifically, the triangle) defined by contact points 601A, 601B, 601C and the current size of object 701. Significantly, in one embodiment, the size of object 701 does not change immediately upon introduction of the third contact point 601C; thus, no discontinuity is introduced.

In one embodiment, triangle 602 is not actually displayed on screen 101, but is shown only for illustrative purposes. In another embodiment, triangle 602 is shown on screen 101.

FIGS. 6D and 7D show the same contact points 601A, 601B, 601C and object 701 dimensions as shown in FIGS. 6C and 7C, emphasizing that after the new relationship between area and object size is determined, no change is immediately made to the size of object 701. Object 701 is still displayed at 125% of its original size. For illustrative purposes, the current area of the triangle defined by contact points 601A, 601B, 601C is set to the arbitrary reference value of 125%.

Subsequent changes to the position(s) of any of contact points 601A, 601B, 601C are interpreted based on the change in area of the triangle defined by contact points 601A, 601B, 601C. Thus, in FIG. 6E, the user's movement of contact points 601A and 601B causes the area of the triangle to increase from the reference value of 125% to a new value of 150%. The change in triangle area is interpreted 307 as a parameter for the zoom gesture, causing object 701 to increase in size by a proportional amount, as shown in FIG. 7E.

In FIGS. 6F and 7F, the same gesture continues, but now the user has removed 310 contact point 601A. Since only two contact points are now provided 302, a relationship 303 is determined between the distance between contact points 601B, 601C and the current size of object 701 along a linear dimension. Again, in one embodiment, the size of object 701 does not change immediately upon removal of contact point 601A; thus, no discontinuity is introduced. However, subsequent movement of one or both of contact points 601B, 601C will be interpreted according to the newly determined relationship between the distance between contact points 601B, 601C and size of object 701.

### Example: Scroll Gesture

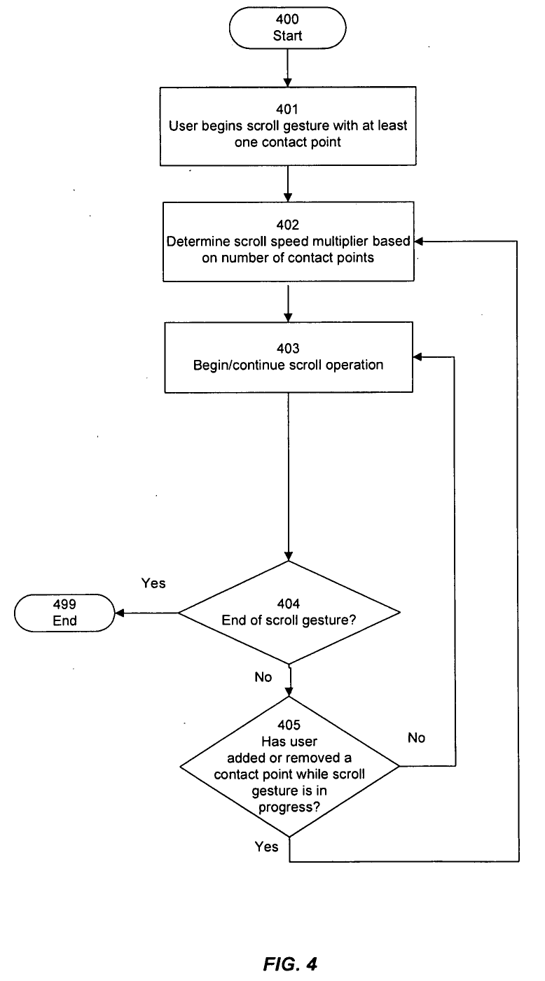

Referring now to FIG. 4, there is shown an example of application of the present invention in another context, namely to change a parameter of a scroll gesture responsive to introduction or removal of a point of contact while the gesture is in progress, according to one embodiment of the present invention. The user begins 401 a scroll gesture with at least one contact point. For example, the user may begin the gesture by placing a finger on the on-screen object to be scrolled.

Device 100 determines 402 a scroll speed multiplier based on the number of contact points. For example, for a single contact point, the multiplier might be 1, while for two contact points, the multiplier might be 10. Thus, a two-fingered scroll gesture would cause scrolling at a rate ten times that of a one-fingered scroll gesture. One skilled in the art will recognize that any multiplier can be used.

The scroll operation begins 403, based on the amount by which user moves the contact point(s), (the base scroll amount) as well as the scroll speed multiplier. Thus, for example, if the user moves the contact point three centimeters when the multiplier is 1, the on-screen object would be scrolled by three centimeters. Alternatively, if the multiplier is 10 (for example for a two-fingered scroll gesture), the on-screen object would be scrolled by thirty centimeters. Of course, if the end of the object is reached, the scroll operation may stop at the endpoint even if the object has not been scrolled by the full amount specified by the gesture.

Device 100 determines 404 whether the scroll gesture has ended, for example by the user removing his fingers from screen 101. If so, the method ends 499.

If the scroll gesture has not ended, device 100 determines 405 whether the user has added or removed a contact point while continuing the zoom gesture. If not, the method returns to step 403 to continue to interpret the scroll gesture as before.

If the user added or removed a contact point while continuing the scroll gesture, device returns to step 402. Step 402 is performed, so as to specify a new scroll speed multiplier based on the new number of contact points. The method then continues with step 403, as described above.

In one embodiment, the new scroll speed multiplier is established in a manner that avoids any substantial discontinuity in the display before and after the introduction or removal of the contact point. Thus, in one embodiment the introduction or removal of the contact point does not itself cause any substantial change to the scroll position of the object being manipulated; however, continuation of the gesture potentially causes subsequent scrolling to take place based on the newly determined scroll speed multiplier.

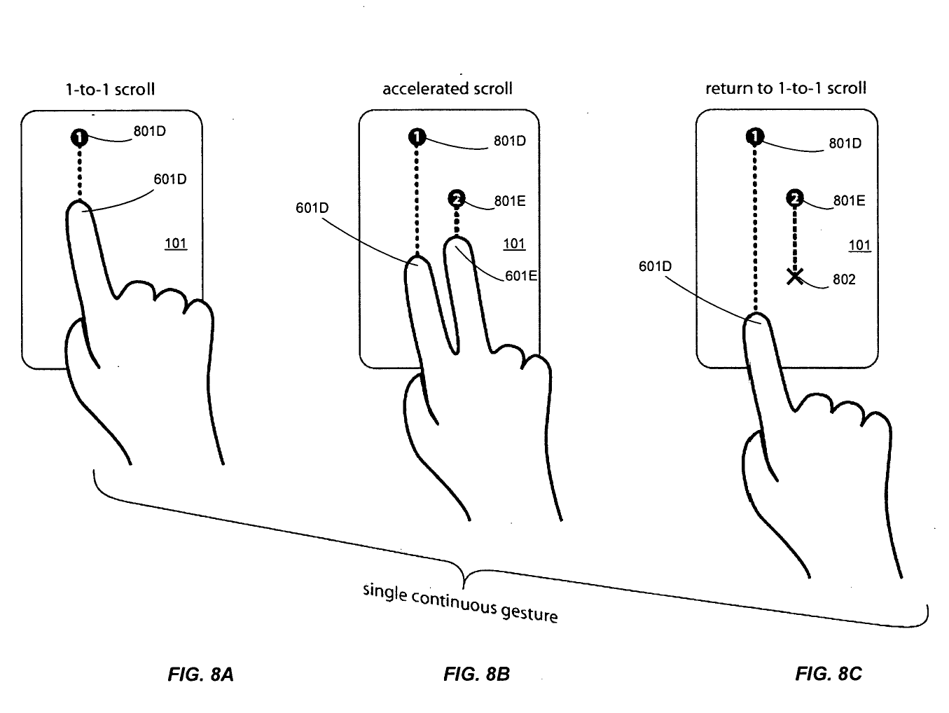

Referring now also to FIGS. 8A through 8C, there is shown an example of a scroll gesture including introduction and removal of a second point of contact while the gesture is in progress, according to one embodiment of the present invention. FIGS. 8A through 8C, along with the following description, are provided to further illustrate the operation of the invention as described in FIG. 4 by way of example, and are not intended to limit the scope of the invention in any way.

In the example of FIGS. 8A through 8C, one continuous scroll gesture is performed. The user adds a contact point and removes a contact point in the process of performing the gesture, and the method of the invention interprets these changes to the gesture to alter the parameters of the scroll operation accordingly and predictably. No change is made to the position of the on-screen object by virtue of the addition or removal of a contact point 602. Rather, subsequent movement of contact points 602 are interpreted based on the number of contact point 602. No discontinuity in the display of the on-screen object is introduced, and the transition from one interpretation of contact points 601 to another is performed smoothly.

In FIG. 8A, the user begins 401 a scroll gesture by dragging a contact point 601D downward on screen 101. FIG. 8A depicts the start point 801D of the gesture. The scroll speed multiplier is determined 402 as 1, because there is one contact point 601D. Accordingly, an on-screen object (not shown for clarity) is scrolled 403 by an amount substantially equal to the distance by which contact point 601D is moved.

In FIG. 8B, the same gesture continues, but now the user has added 405 a second contact point 601E. FIG. 8B depicts the start point 801E for the new contact point 601E. The user has continued to move both fingers downward as the second contact point 601E is introduced. The addition of the second contact point 601E causes the scroll speed multiplier to be determined 402 as 10. Accordingly, continued scrolling of the on-screen object (not shown for clarity) proceeds by an amount substantially equal to ten times the distance by which contact point s 601D and 601E are moved.

In FIG. 8C, the same gesture continues, but now the user has removed 405 the second contact point 601E. FIG. 8C depicts the start point 801E and the end point 802 for the contact point 601E that was shown in FIG. 8B. The user has continued to move one finger downward as the second contact point 601E is removed, causing contact point 601D to continue to move. The removal of the second contact point 601E causes the scroll speed multiplier to revert to 1. Accordingly, continued scrolling of the on-screen object (not shown for clarity) proceeds by an amount substantially equal to the distance by which contact point 601D is moved.

### Example: Rotate Gesture

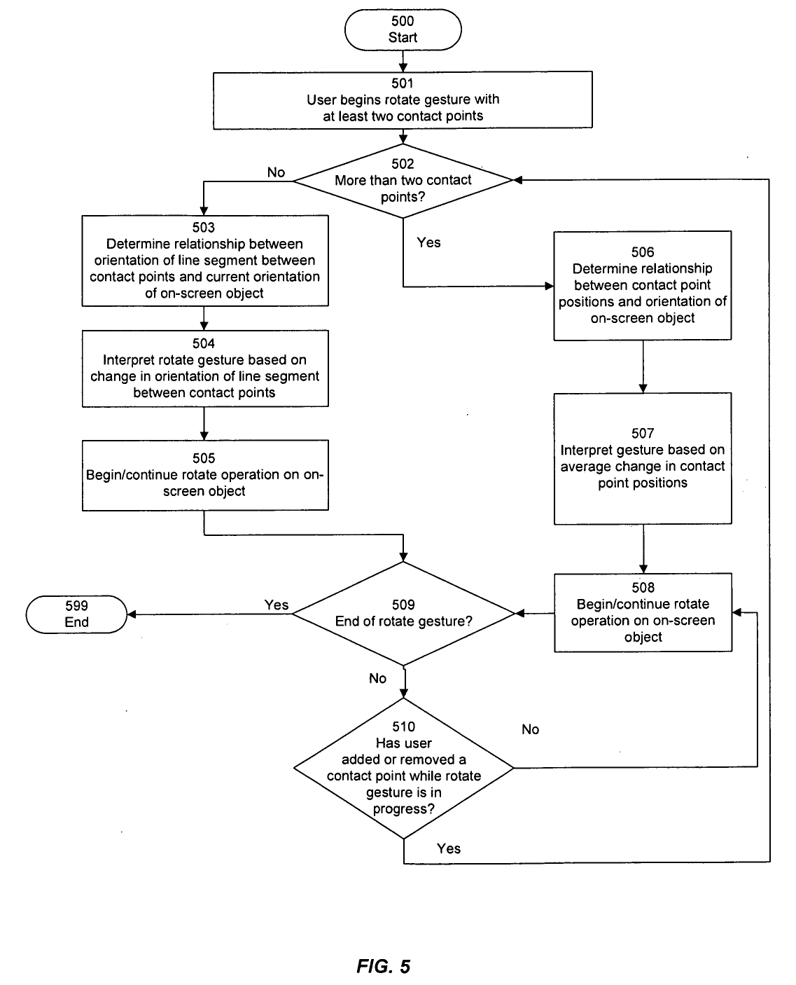

Referring now to FIG. 5, there is shown an example of application of the present invention in another context, namely to change a parameter of a rotate gesture responsive to introduction or removal of a point of contact while the gesture is in progress, according to one embodiment of the present invention. The user begins 501 a rotate gesture with at least two contact points. For example, the user may begin the gesture by placing two fingers on the on-screen object to be rotated.

A determination is made 502 whether the gesture includes more than two contact points. If exactly two contact points are included, the rotate operation will be performed according to the change in orientation of a line segment drawn between the two contact points. A relationship is determined 503 between the orientation of such a line segment and the current orientation of the object being manipulated by the rotate operation. Then, the rotate gesture is interpreted 504 based on the change in orientation of the line segment drawn between the two contact points as the user continues the rotate gesture. Device 100 begins 505 to perform the rotate operation on the on-screen object according to the interpreted rotate gesture. Thus, for example, if the user moves his or her fingers so that the constructed line segment between the contact points rotates by 30 degrees, the on-screen object is rotated by 30 degrees.

In one embodiment, the line segment is not actually displayed on screen 101. In another embodiment, the line segment is shown on screen 101.

If, in step 502, more than two contact points are included, the rotate operation will be performed according to the average amount of rotational movement performed by the user on the contact points. Thus, if the user moves all contact points to rotate them around a point, the on-screen object rotates by a substantially similar amount. If the user moves a subset of the contact points, the on-screen object rotates according to the proportion of contact points moved and according to the amount by which they are moved.

A relationship is determined 506 between the contact point positions and the current orientation of the object being manipulated by the rotate operation. Then, the rotate gesture is interpreted 507 based on the average rotational movement of the contact points as the user continues the rotate gesture. Thus, if three contact points are presented, and two points remain stationary while one point moves, the object will be rotated by one-third of the amount of rotational movement of the third point. Device 100 begins 508 to perform the rotate operation on the on-screen object according to the interpreted rotate gesture.

Device 100 determines 509 whether the rotate gesture has ended, for example by the user removing his fingers from screen 101. If so, the method ends 599.

If the rotate gesture has not ended, device 100 determines 510 whether the user has added or removed a contact point while continuing the rotate gesture. If not, the method returns to step 502 to continue to interpret the rotate gesture as before.

If the user added or removed a contact point while continuing the rotate gesture, device returns to step 502. Step 503 or 506 is performed, so as to effectively reset the relationship between the contact point positions and the current orientation of the object being manipulated. Specifically, if exactly two contact points are included, the relationship is determined 503 between the orientation of a line segment between the contact points and the current orientation of the object. Conversely, if more than two contact points are included, the relationship is determined 506 between the contact point positions and the orientation of the object. The method then continues with either step 504 or 507, as described above.

In one embodiment, the relationship between contact points and the manipulated object is reset (by the determining steps 503 and/or 506) in a manner that avoids any substantial discontinuity in the display before and after the introduction or removal of the contact point. Thus, in one embodiment the introduction or removal of the contact point does not itself cause any substantial change to the orientation of the object being manipulated; however, continuation of the gesture potentially causes subsequent change to the object based on the newly determined relationship between the object and the contact points.

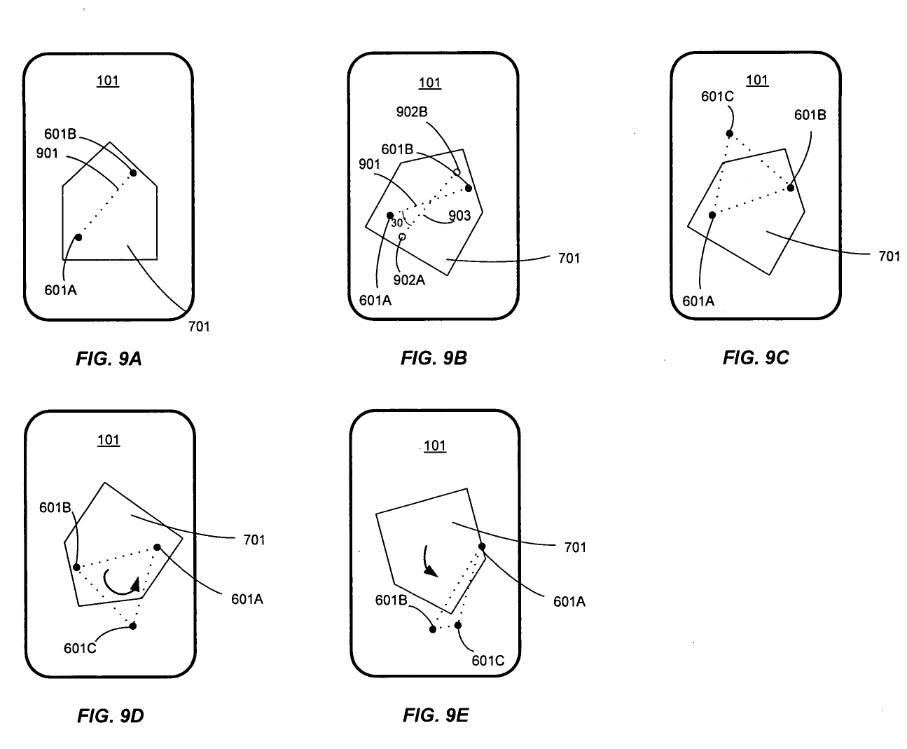

Referring now also to FIGS. 9A through 9E, there is shown an example of the effect of a rotate gesture on an on-screen object 701, including introduction of a point of contact while the gesture is in progress, according to one embodiment of the present invention. FIGS. 9A through 9E, along with the following description, are provided to further illustrate the operation of the invention as described in FIG. 5 by way of example, and are not intended to limit the scope of the invention in any way.

In the example of FIGS. 9A through 9E, one continuous rotate gesture is performed. The user adds a contact point in the process of performing the gesture, and the method of the invention interprets these changes to the gesture to alter the parameters of the rotate operation accordingly and predictably. No discontinuity in the display of object 701 is introduced, and the transition from one interpretation of contact points 601 to another is performed smoothly.

In FIG. 9A, the user begins 501 a rotate gesture with two original contact points 601A, 601B. Since two contact points are provided 502, a relationship 503 is determined between the orientation of line segment 901 between contact points 601A, 601B and the current orientation of on-screen object 701.

In FIG. 9B, the user moves his or her fingers while maintaining contact with screen 101, causing contact points 601A, 601B to change position such that line segment 901 rotates by 30 degrees in a clockwise direction. As mentioned above, line segment 901 need not be (but may be) displayed on screen 101. Previous positions 902A, 902B of contact points 601A, 601B are shown in FIG. 9B for illustrative purposes, along with previous orientation 903 of line segment 901.

The rotate gesture is interpreted 504 based on this change in orientation of line segment 901, and the rotate operation begins 505: specifically, object 701 is rotated by 30 degrees in a clockwise direction.

In FIG. 9C, the same gesture continues, but now the user has added 510 a third contact point 601C. Since more than two contact points are now provided 502, a relationship 506 is determined between contact point positions 601A, 601B, 601C and the current orientation of object 701. Significantly, in one embodiment, the orientation of object 701 does not change immediately upon introduction of the third contact point 601C; thus, no discontinuity is introduced.

In one embodiment, the triangle formed by contact point positions 601A, 601B, 601C is not actually displayed on screen 101, but is shown only for illustrative purposes. In another embodiment, this triangle is shown on screen 101.

Subsequent changes to the position(s) of any of contact points 601A, 601B, 601C are interpreted based on the average rotational change in contact point positions. Thus, in the example where three contact points 601A, 601B, 601C are presented, if two points remain stationary and one point moves, object 701 will be rotated by one-third of the amount of rotational movement of the third point

In FIG. 9D, the user's movement of contact points 601A, 601B, 601C represents rotational movement of all three contact points 601A, 601B, 601C. Accordingly, this rotational movement is interpreted 507 as a parameter for the rotate gesture, causing object 701 to rotate by a proportional amount, as shown in FIG. 9D.

In FIG. 9E, the user moves contact point 601B but holds contact points 601A, 601C stationary. Thus, one-third of the contact points have moved. This causes object 701 to rotate by one-third of the amount of rotational movement of contact point 601B.

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

Reference herein to “one embodiment”, “an embodiment” , or to “one or more embodiments” means that a particular feature, structure, or characteristic described in connection with the embodiments is included in at least one embodiment of the invention. Further, it is noted that instances of the phrase “in one embodiment” herein are not necessarily all referring to the same embodiment.

Some portions of the above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention can be embodied in software, firmware or hardware, and when embodied in software, can be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Further, the computers referred to herein may include a single processor or may be architectures employing multiple processor designs for increased computing capability.

The algorithms and displays presented herein are not inherently related to any particular computer, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description above. In addition, the present invention is not described with reference to any particular programming language. It will be appreciated that a variety of programming languages may be used to implement the teachings of the present invention as described herein, and any references above to specific languages are provided for disclosure of enablement and best mode of the present invention.

While the invention has been described with respect to a limited number of embodiments, those skilled in the art, having benefit of the above description, will appreciate that other embodiments may be devised which do not depart from the scope of the present invention as described herein. In addition, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

What is claimed is:

1. A method for interpreting gesture input on a touch-sensitive surface, comprising:
receiving input representing a gesture, the input comprising at least one initial point of contact with the touch-sensitive surface;
determining at least one parameter for the gesture, according to the at least one point of contact;
performing an operation associated with the received gesture input, according to the determined at least one parameter;
outputting a result of the performed operation on an output device;
receiving additional input representing a continuation of the gesture, the additional input comprising at least one additional point of contact with the touch-sensitive surface;
changing at least one previously determined parameter for the gesture according to the at least one initial point of contact and the at least one additional point of contact;
continuing the operation associated with the received gesture input, according to the changed at least one parameter; and
outputting a result of the continued operation on the output device.

2. The method of claim 1, wherein the touch-sensitive surface comprises a touch-sensitive display screen, and wherein:
receiving input comprises detecting user contact with the touch-sensitive display screen; and
receiving additional input comprises detecting additional user contact with the touch-sensitive display screen.

3. The method of claim 1, further comprising:
displaying an object on a display screen;
and wherein:
performing an operation associated with the received gesture input comprises manipulating the displayed object; and
continuing the operation associated with the received gesture input comprises continuing to manipulate the displayed object.

4. The method of claim 3, wherein manipulating the displayed object comprises at least one selected from the group consisting of:
zooming the displayed object;
rotating the displayed object;
moving the displayed object;
distorting the displayed object;
stretching the displayed object;
scrolling the displayed object; and
scaling the displayed object.

5. The method of claim 3, wherein:
determining at least one parameter for the gesture comprises determining a first relationship between the at least one initial point of contact and the displayed object;
performing the operation comprises manipulating the displayed object according to the determined first relationship;
changing at least one previously determined parameter for the gesture comprises determining a second relationship between the points of contact and the displayed object; and
continuing the operation comprises manipulating the displayed object according to the determined second relationship.

6. The method of claim 6, wherein:
determining the second relationship for the gesture comprises establishing the second relationship so as to maintain continuity of the appearance of the displayed object.

7. The method of claim 1, further comprising:
receiving additional input representing a continuation of the gesture, the additional input comprising removal of at least one point of contact;
changing at least one previously determined parameter for the gesture according to at least one remaining point of contact; and
continuing the operation associated with the received gesture input, according to the changed at least one parameter.

8. The method of claim 1, wherein the operation associated with the received gesture input comprises at least one selected from the group consisting of:
a zoom operation;
a rotate operation;
a move operation;
a distort operation;
a stretch operation;
a scroll operation; and
a scale operation.

9. The method of claim 1, wherein:
the received input represents a zoom gesture, and comprises two initial points of contact with the touch-sensitive surface;
determining at least one parameter for the gesture comprises determining a first zoom factor responsive to a change in distance between the two initial points of contact;
performing the operation comprises performing a zoom operation according to the first zoom factor;
changing at least one previously determined parameter for the gesture comprises determining a second zoom factor responsive to a change in area of a polygon defined by the two initial points of contact and the at least one additional point of contact; and
continuing the operation comprises continuing the zoom operation according to the second zoom factor.

10. The method of claim 1, wherein:
the received input represents a scroll gesture, and comprises at least one initial point of contact with the touch-sensitive surface;
determining at least one parameter for the gesture comprises determining a first scroll amount responsive to the number of initial points of contact and an amount of movement of the at least one initial point of contact;
performing the operation comprises performing a scroll operation according to the first scroll amount;
changing at least one previously determined parameter for the gesture comprises determining a second scroll amount responsive to the number of points of contact including the at least one initial point of contact and the at least one additional point of contact, and further responsive to an amount of movement of at least one of the points of contact; and
continuing the operation comprises continuing the scroll operation according to the second scroll amount.

11. The method of claim 10, wherein:
determining a first scroll amount comprises:
determining a first scroll speed multiplier based on the number of initial points of contact;
determining a first base scroll amount based on the amount of movement of the at least one initial point of contact; and
combining the first scroll speed multiplier with the first base scroll amount to generate a first scroll amount; and
determining a second scroll amount comprises:
determining a second scroll speed multiplier based on the number of points of contact including the at least one initial point of contact and the at least one additional point of contact;
determining a second base scroll amount based on the amount of movement of at least one of the points of contact; and
combining the second scroll speed multiplier with the second base scroll amount to generate a second scroll amount.

12. The method of claim 1, wherein:
the received input represents a rotate gesture, and comprises two initial points of contact with the touch-sensitive surface;
determining at least one parameter for the gesture comprises determining a first rotate factor responsive to a change in orientation of a line segment between the two initial points of contact;
performing the operation comprises performing a rotate operation according to the first rotate factor;
changing at least one previously determined parameter for the gesture comprises determining a second rotate factor responsive to an average rotational motion of the points of contact; and
continuing the operation comprises continuing the rotate operation according to the second rotate factor.

13. The method of claim 1, wherein:
determining at least one parameter for the gesture comprises determining the at least one parameter responsive to at least one selected from the group consisting of:
a position of the at least one initial point of contact;
an amount of movement of the at least one initial point of contact; and
a direction of movement of the at least one initial point of contact; and
changing at least one previously determined parameter for the gesture comprises changing at least one previously determined parameter responsive to at least one selected from the group consisting of:
a position of the at least one additional point of contact;
an amount of movement of the at least one additional point of contact; and
a direction of movement of the at least one additional point of contact.

14. The method of claim 1, wherein the additional input representing a continuation of the gesture is received during performance of the operation.

15. The method of claim 1, wherein each parameter comprises at least one selected from the group consisting of:
a speed for the gesture;
an amount for the gesture;
a factor for the gesture; and
a magnitude for the gesture.

16. A method for interpreting gesture input on a touch-sensitive surface, comprising:
receiving input representing a gesture, the input comprising at least two initial points of contact with the touch-sensitive surface;
determining at least one parameter for the gesture, according to the at least two points of contact;
performing an operation associated with the received gesture input, according to the determined at least one parameter;
outputting a result of the performed operation on an output device;
receiving additional input representing a continuation of the gesture, the additional input comprising removal of at least one point of contact with the touch-sensitive surface;
changing at least one previously determined parameter for the gesture according to at least one remaining point of contact;
continuing the operation associated with the received gesture input, according to the changed at least one parameter; and
outputting a result of the continued operation on the output device.

17. A system for interpreting gesture input on a touch-sensitive surface, comprising:
a touch-sensitive surface, for receiving input representing a gesture, the input comprising at least one initial point of contact with the touch-sensitive surface;
a processor, for:
determining at least one parameter for the gesture, according to the at least one point of contact;
performing an operation associated with the received gesture input, according to the determined at least one parameter; and
an output device, for displaying a result of the operation;
wherein:
the touch-sensitive surface receives additional input representing a continuation of the gesture, the additional input comprising at least one additional point of contact with the touch-sensitive surface;
the processor changes at least one previously determined parameter for the gesture, according to the at least one initial point of contact and the at least one additional point of contact, and continues the operation associated with the received gesture input, according to the changed at least one parameter; and
the output device displays the result of the continued operation.

18. The system of claim 17, wherein:
the output device displays an object; and
the processor:
performs the operation by manipulating the displayed object; and
continues the operation by continuing to manipulate the displayed object.

19. The system of claim 18, wherein the processor manipulates the displayed object by performing at least one selected from the group consisting of:
zooming the displayed object;
rotating the displayed object;
moving the displayed object;
distorting the displayed object;
stretching the displayed object;
scrolling the displayed object; and
scaling the displayed object.

20. A system for interpreting gesture input on a touch-sensitive surface, comprising:
a touch-sensitive surface, for receiving input representing a gesture, the input comprising at least two initial points of contact with the touch-sensitive surface;
a processor, for:
determining at least one parameter for the gesture, according to the at least two points of contact;
performing an operation associated with the received gesture input, according to the determined at least one parameter; and
an output device, for displaying a result of the operation;
wherein:
the touch-sensitive surface receives additional input representing a continuation of the gesture, the additional input comprising removal of at least one point of contact with the touch-sensitive surface;
the processor changes at least one previously determined parameter for the gesture, according to at least one remaining point of contact, and continues the operation associated with the received gesture input, according to the changed at least one parameter; and
the output device displays the result of the continued operation.
